(19) United States
(12) Patent Application Publication
(10) Pub. No.: US 2026/0067310 A1
(43) Pub. Date: Mar. 5, 2026

(54) SYSTEM AND METHOD FOR DETECTION OF VOLUMETRIC MALICIOUS ATTACKS ON DATACENTER NETWORKS

(71) Applicant: OVH, Roubaix (FR)

(72) Inventors: Clement BOIN, Lille (FR); Benjamin LOPEZ, Hem (FR); Charlelie RAVAIL, Lyon (FR); Christophe BACARA, Wasquehal (FR); Xavier GUILLAUME, Roubaix (FR)

(21) Appl. No.: 19/284,877

(22) Filed: Jul. 30, 2025

(30) Foreign Application Priority Data
Aug. 28, 2024 (EP) 24306408.6

(51) Int. Cl. H04L 9/40

(52) U.S. Cl. CPC H04L 63/1425; H04L 63/1416; H04L 63/1458

(57) ABSTRACT

A method and system for detecting volumetric malicious threats by iteratively aggregating network flow information of received packet data is presented that includes: analyzing the network flow information of the received packet data; assigning a time interval window, based on the network flow information for time aggregation; determining a corresponding datacenter (DC), based on the network flow destination IP information for DC aggregation; determining a corresponding subnet IP range, based on the network flow destination IP information for subnet aggregation; and determining a transport protocol for corresponding servers of the IP subnet. The packet data size and/or number of packets for the subnet transport protocol and the server transport protocol are updated based on the received packet data. And upon detection that the subnet or server transport protocol updated packet size/number of packets exceed predefined thresholds, issue alerts indicating a potential volumetric malicious threat.

### CROSS-REFERENCE

The present application claims priority to European Patent Application No. 24306408, filed Aug. 28, 2024, and entitled “SYSTEM AND METHOD FOR DETECTION OF VOLUMETRIC MALICIOUS ATTACKS ON DATACENTER NETWORKS”, the entirety of which is incorporated herein by reference.

### TECHNICAL FIELD

The present disclosure generally relates to network traffic engineering analytics of datacenter networks, and in particular, to the detection of volumetric malicious threats on datacenter networks.

### BACKGROUND

In servicing client demands, datacenter networks must be configured with the necessary resources to adequately process massive amounts of network traffic data on almost a real-time basis. At the same time, datacenters must also monitor the flow status of network traffic to detect any issues with the security and/or performance of the network or related network elements.

The detection of potential malicious threats are typically directed to distributed denial of service (DDoS) attacks that target a specific host/server with a bombardment of malicious packet data. However, recently, there appears to be a different mode of DDoS attacks that, instead of bombarding a specific host/server, the attacks are directed to transmitting limited quantities of malicious packet data to a multiple servers belonging to a subnet of a datacenter network which functions to eventually saturate the corresponding switch/router. This malicious attack mode has been referred to as volumetric or “carpet bombing,” which is difficult to detect by conventional network analytical techniques.

Therefore, there is an interest in providing a monitoring process capable of detecting malicious threats, such as DDoS carpet bombing attacks.

### SUMMARY

The embodiments of the present disclosure have been designed based on the developers' appreciation of the drawbacks and issues associated with current network information flows difficulties in detecting volumetric malicious/carpet bombing attacks.

As such, the embodiments of the present technology are defined by the appended set of claims.

Accordingly, there is provided a method for detecting malicious threats by iteratively aggregating network flow information of received packet data including analyzing the network flow information of the received packet data; assigning a time interval window, based on the network flow information of the received packet data, for time aggregation; determining a corresponding datacenter (DC), based on the network flow destination IP information of the received packet data, for DC aggregation; determining a corresponding subnet IP range, based on the network flow destination IP information of the received packet data, for subnet aggregation; evaluating a transport protocol for the subnet IP range and updating the packet data size and/or number of packets based on the received packet data; determining whether the updated packet data size and/or number of packets of the transport protocol for the subnet IP range exceeds a first predefined threshold value; evaluating a transport protocol for corresponding servers of the IP subnet and updating the packet data size and/or number of packets based on the received packet data; and determining whether the updated packet data size and/or number of packets of the transport protocol for the servers exceeds a second predefined threshold.

Moreover, upon determining that the transport protocol for the subnet IP range contains updated packet data size and/or number of packets exceeding the first predefined threshold value, issue an alert indicating the detection of a potential threat and upon determining that the transport protocol for the servers contains updated packet data size and/or number of packets that exceeds a second predefined threshold value, issue an alert indicating the detection of a potential threat.

In some aspects, the method additionally comprises provisioning additional destination IP addresses requested by a client by providing additional destination IP addresses requested by client; performing a lookup function of a database to identify stored prior registered IP addresses belonging to the requesting client; associating the additional destination IP addresses into the database, based on the identified stored prior registered IP addresses; and registering and storing the additional IP addresses associated with the requesting client in the database.

Additionally, there is also provided a system for detecting malicious threats by iteratively aggregating network flow information of received packet data that includes a network communications infrastructure configured to facilitate transport of the received packet data and to direct the received packet data to an intended destination, based on the corresponding network flow information of the received packet data identifying a destination IP address; at least one datacenter (DC), in communications with the network communications infrastructure, comprising at least one top-of-rack (ToR) network switching device configured to manage a plurality of servers associated with an IP subnet; a time aggregation layer configured to assign a time interval window for the received packet data based on the corresponding network flow information identifying a start time and end time; a DC aggregation layer configured to determine a corresponding DC that services a range of IP addresses encompassing the destination IP address based on the network flow information identified destination IP address; a subnet aggregation layer configured to: determine an IP subnet and related subnet transport protocol based on the network flow information, evaluate the subnet transport protocol and update the packet data size and/or number of packets based on the received packet data network flow information, and determine whether the updated packet data size and/or number of packets of the subnet transport protocol exceeds a first predefined threshold value; and a server aggregation layer configured to: determine server(s) corresponding to the IP subnet and related server transport protocol based on the network flow information, evaluate the server transport protocol and update the packet data size and/or number of packets based on the received packet data network flow information, and determine whether the updated packet data size and/or number of packets of the server transport protocol exceeds a second predefined threshold value.

Furthermore, upon determining that the transport protocol for the subnet IP range contains updated packet data size and/or number of packets exceeding the first predefined threshold value, issue an alert indicating the detection of a potential threat and upon determining that the transport protocol for the servers contains updated packet data size and/or number of packets that exceeds a second predefined threshold value, issue an alert indicating the detection of a potential threat.

In some aspects, the system additionally comprises a future aggregation layer configured to: provide additional destination IP addresses requested by a client; perform a lookup function of a database to identify prior stored registered IP addresses belonging to the requesting client; associate the additional destination IP addresses with the requesting client, based on the identified stored prior registered IP addresses; and register and store the additional IP addresses associated with the requesting client in the database.

It will be appreciated that additional and/or alternative features, aspects, and advantages of the present technology will become apparent from the following description, accompanying drawings, and the appended claims.

### BRIEF DESCRIPTION OF THE FIGURES

Further features and advantages of the present disclosure will become apparent from the following detailed description taken in combination with the appended drawings, in which:

FIG. 1 depicts a high-level conceptual diagram of a network topology, in accordance with the embodiments of the present disclosure;

FIGS. 2A, 2B, and 2C depict aspects of a functional flow of an aggregation processing architecture for detecting malicious threats, in accordance with the embodiments of the present disclosure;

FIG. 3 depicts a method flowchart for detecting malicious threats based on the aggregation process of FIGS. 2A-2C, in accordance with the embodiments of the present disclosure;

FIG. 4 depicts a method flowchart for future aggregations to detect malicious threats, in accordance with the embodiments of the present disclosure; and

FIG. 5 depicts an exemplary computing environment for implementing and/or executing any of the methods described herein, in accordance with the embodiments of the present disclosure.

It is to be understood that throughout the appended drawings and corresponding descriptions, like features are identified by like reference characters and that the drawings are not to scale. It should also be understood that the drawings and ensuing descriptions are intended for illustrative purposes only and that such disclosures are not intended to limit the scope of the claims.

### DETAILED DESCRIPTION

The present disclosure is directed to addressing at least some of the drawbacks and issues associated with current network information flows difficulties in detecting malicious volumetric/carpet bombing threats or attacks.

It will be understood, however, that the examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity. In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology.

Moreover, where no examples of modifications have been set forth, it should not be interpreted that no modifications are possible and/or that what is described is the sole manner of implementing that element of the present technology. As such, all statements herein reciting principles, aspects, and implementations of the present technology, as well as specific examples thereof, are intended to encompass both structural and functional equivalents thereof, whether they are currently known or developed in the future.

It will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

Similarly, functions of the various elements shown in the figures, including any functional block labeled as a “processor”, may be provided through the use of dedicated hardware as well as hardware capable of executing software in association with appropriate software.

Additionally, to the extent that the phrase “at least one of A and B” is used in the description and claims, it will be understood that this phrase is intended to mean “A only”, “B only” or both “A and B”.

With these fundamentals in place, presented heretofore are non-limiting embodiments that illustrate various aspects and implementations of the present disclosure.

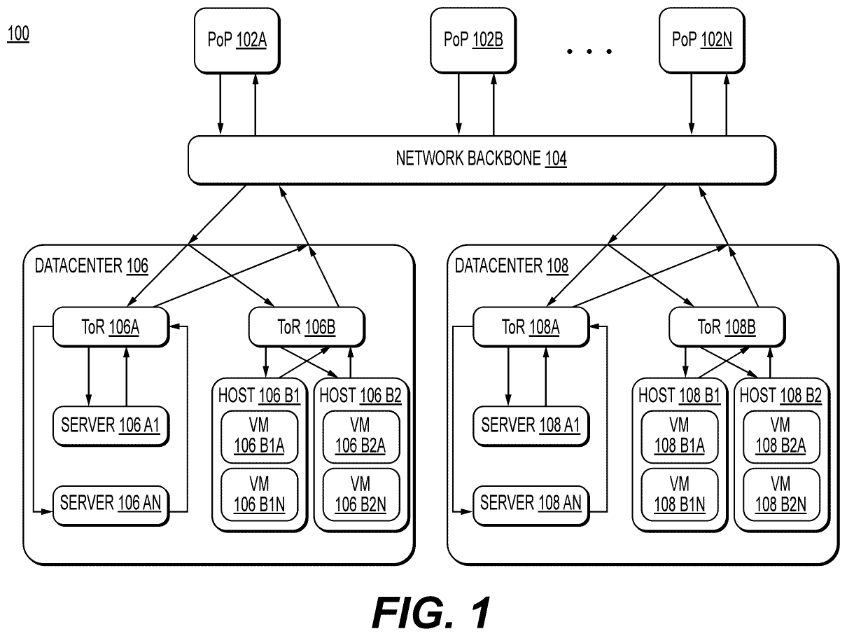

FIG. 1 depicts a high-level conceptual diagram of a network topology 100, in accordance with the embodiments of the present disclosure. As shown, network topology 100 comprises point-of-presence (POP) network devices 102A-N that provide packet data traffic to a network communications infrastructure 104. The network communications infrastructure 104 then directs the packet data traffic to corresponding datacenters based on the IP destination addresses of the packet data.

By way of a nonlimiting illustration, the network communications infrastructure 104 is shown to direct the packet data traffic to datacenters 106, 108. Again, for purposes of clarity, datacenters 106, 108 are shown to include top-of-rack (ToR) network switching/routing devices 106A, 108A, respectively. The ToR routing devices 106A, 108A are configured to provide packet data routing services to designated IP subnet destination ranges. The packet data is then routed to dedicated network servers 106A1-106AN, 108A1-108AN, respectively, that have destination IP addresses that fall within the designated IP subnet destination ranges. In certain embodiments, the designated IP subnet range may include up to 256 network servers, respectively, under the routing control of the ToR routing devices 106A, 108A.

Additionally, datacenters 106, 108 are also shown to include top-of-rack (ToR) routing devices 106B, 108B, respectively, that route packet data to host network devices 106B1, 106B2, 108B1, 108B2. These host network devices 106B1, 106B2, 108B1, 108B2 operate to route packet data to corresponding virtual machines (VM) 106B1A-BIN, 106B2A-B2N and 108B1A-BIN, 108B2A-B2N, based on the designated destination IP addresses. In certain embodiments, the designated IP addresses may include up to 256 VMs, respectively, under the routing control of the ToR routing devices 106B, 108B.

Moreover, network topology 100 utilizes network flow information processes that observe traffic-related metadata, such as, for example, source/destination IP addresses, port source/destination, number of packets, total size of payload, transmission/reception times, etc. for traffic flowing across network devices, such as, for example, switches, routers, hosts, etc. The network flow information may operate under the netflow standard, sflow standard, or any suitable network flow-oriented standard capable of communicating network flow information of network devices throughout the network.

Armed with such network flow information, network topology 100 is able to compute expected bandwidth for specific or ranges of IP addresses for network devices as well as establishing and defining thresholds regarding total received packet data size and total number of received packets based on clients' network capacities and categories (i.e., gaming, internal services, storage, etc.).

As noted above, “carpet bombing” attacks are directed to transmitting limited quantities of malicious packet data to a datacenter network switch/router that services multiple servers having different individual destination IP addresses under a corresponding IP subnet. Because of the limited amount of malicious packet data that distributed among multiple servers, carpet bombing is difficult to detect by conventional analytical techniques.

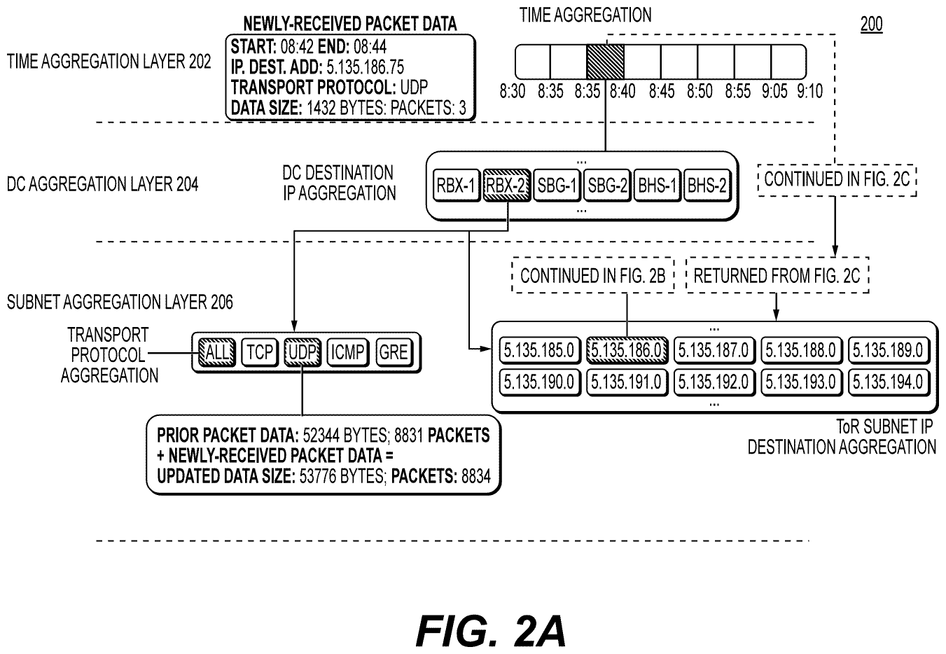

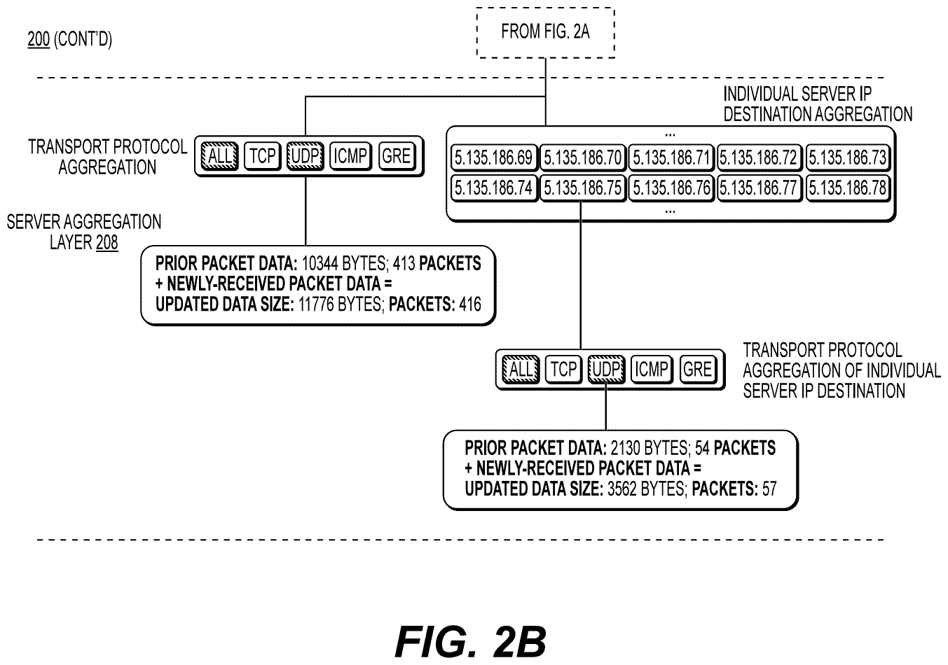

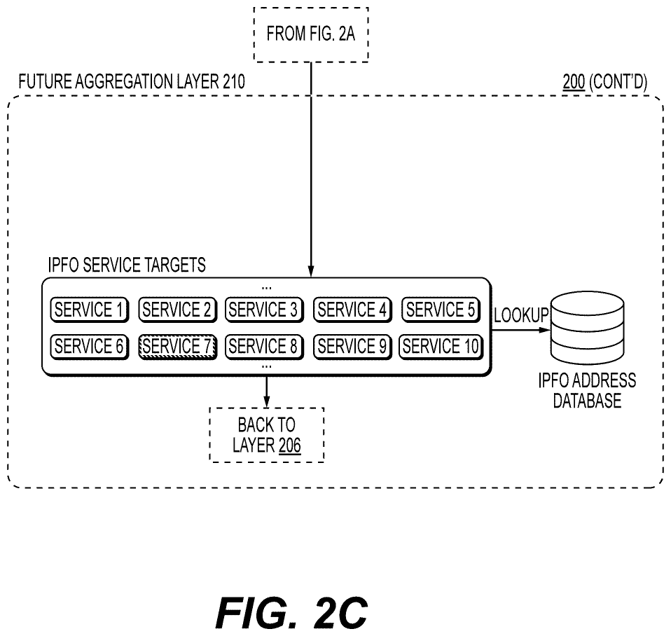

Accordingly, FIGS. 2A, 2B, 2C depict aspects of a functional flow of aggregation processing architecture 200 for detecting malicious threats, including DDoS carpet bombing attacks, in accordance with the embodiments of the present disclosure. As shown, aggregation processing architecture 200 is a multi-layered aggregation detection architecture configured to aggregate all potential packet data threats that are distributed among multiple servers pertaining to an IP subnet to detect DDoS carpet bombing attacks directed to incapacitating network routing devices 106A, 108A in control of multiple servers.

As depicted, aggregation processing architecture 200 comprises a time aggregation layer 202, a datacenter (DC) aggregation layer 204, a subnet aggregation layer 206, a server aggregation layer 208, and a future aggregation layer 210. As will be described in greater detail below, aggregation processing architecture 200 utilizes network flow information to analyze and process newly-received packet data that is iteratively accumulated to determine whether the network flow information indicates metrics exceeding established thresholds for the aggregation layers 202, 204, 206, and 208.

In particular, as shown in FIG. 2A, new packet data is received having network flow information in which processing architecture 200 determines, based on the network flow information, the received start and end times, IP destination address, defined transport protocol, overall payload packet data size, and number of discrete packets for the received packet data. The selection of the new packet data to be received is generally based on netflow information processes, such as a netflow traffic-based sampling or statistical algorithm. In the nonlimiting illustrated example, the newly-received packet data has been determined to comprise 3 discrete packets having a packet data size of 1432 bytes.

The time aggregation layer 202 of processing architecture 200 assigns a corresponding predefined time interval window based on the received start and end times of the newly-received packet data. The time aggregation layer 202 is configured to aggregate traffic data for a variety of different time window resolutions, such, for example, 100 ms, 1,000 ms, 10,000 ms, etc. In the nonlimiting illustrated example, the network flow information of the newly-received data packet has a start and end time between 8:42 and 8:44, in which the time aggregation layer 202 assigns it to a corresponding predefined time interval window of 8:40 to 8:45.

Upon assigning the newly-received packet data to the corresponding time interval window, aggregation processing architecture 200 then analyzes the received packet data under the datacenter (DC) aggregation layer 204. The DC aggregation layer 204 is configured to identify which datacenter the newly-received packet data is directed to, based on the IP destination address, as discerned from the related network flow information. In the nonlimiting illustrated example, the newly-received packet data has a destination IP address of 5.135.186.75 which is identified as belonging to datacenter RBX-2.

After identifying the corresponding datacenter, aggregation processing architecture 200 then analyzes the newly-received data packet under the subnet aggregation layer 206. The subnet aggregation layer 206 is configured to determine the corresponding IP subnet destination ranges and the corresponding ToR routing device, as discerned from the related network flow information. The subnet aggregation layer 206 also performs transport protocol aggregation for the determined IP subnet destination ranges. In the nonlimiting illustrated example, based on the destination IP address of 5.135.186.75, the newly-received packet data is determined to belong to the IP destination subnet 5.135.186.0. Relatedly, the transport protocol aggregation determines that the corresponding protocol is UDP in which the packet data transported by UDP, prior to the newly-received packet data, comprised 8831 packets having a total data size of 52344 and, after receipt of the new packet data (e.g., 3 packets having a total size of 1432 bytes), the resulting updated packet metrics are 8834 packets having a total size of 53776 bytes.

At this subnet aggregation layer 206, if it is determined that the updated number of received packets and/or updated total packet data size exceeds a pre-defined threshold for the corresponding destination subnet 5.135.186.0, processing architecture 200 sends an alert indicating a potential threat/attack has been detected. The subnet aggregation layer 206 is configured to iteratively continue to update the number of packets and packet data size accumulated thus far and determine any threshold breaches for future received packet data provided by the same transport protocol (e.g., UDP) for the same corresponding destination subnet (e.g., 5.135.186.0).

Turning to FIG. 2B, after assessing and aggregating the subnet destination IP, the aggregation processing architecture 200 moves onto the server aggregation layer 208 to analyze the metrics for the corresponding subnet transport protocol, beginning with the destination IP address of 5.135.186.75 for the individual server, as discerned from the related network flow information as well as analyzing the metrics for the transport protocol of the specific individual server having the destination IP address of 5.135.186.75.

In the non-limiting illustrated example, the server aggregation layer 208 aggregates the subnet transport protocol to determine that the corresponding UDP protocol has transported packet data comprising 413 packets having a total data size of 10344 bytes, prior to the newly-received packet data. After receipt of the new packet data (e.g., 3 packets having a total size of 1432 bytes), the resulting updated packet metrics are 416 packets having a total size of 11776 bytes. Then layer 208 aggregates the individual server transport protocol to determine that the corresponding UDP protocol has transported packet data comprising 54 packets having a total data size of 2130 bytes, prior to the newly-received packet data. And, after receipt of the new packet data, the resulting updated packet metrics are 57 packets having a total size of 3562 bytes.

At this server aggregation layer 208, if it is determined that the number of received packets and/or received total packet data size exceed a defined threshold, processing architecture 200 sends an alert indicating a potential threat/attack has been detected.

Turning over to FIG. 2C, processing architecture 200 also has the capability of providing future aggregating operations and protection of additional/alternative IP addresses in case of IP failovers (IPFO). In particular, future aggregation layer 210 allows clients to request and acquire additional destination IP addresses that are not related to client's prior registered IP subnet addresses and that operate as failover addresses that can seamlessly switch between servers. The future aggregation layer 210 employs an IPFO database containing all IPFO and corresponding clients. As such, future aggregation layer 210 performs accesses the IPFO database and performs a “lookup” function to identify what prior registered subnet IP addresses belong to the requesting client. Upon identifying the client's prior registered subnet IP addresses, the additional IP addresses are associated and registered with the client as well as the prior registered subnet IP addresses. The future aggregation layer 210 then returns back to the subnet aggregation layer 206 of processing architecture 200 for continued aggregation processing of the layers. Therefore, if an attack on a server is detected, all IP addresses corresponding to the specific client will be addressed.

In this manner, aggregation processing architecture 200 utilizes network flow information to analyze and process newly-received packet data that is iteratively accumulated for each layer to detect smaller quantities of malicious packet data that are spread across multiple servers to eventually saturate networking equipment.

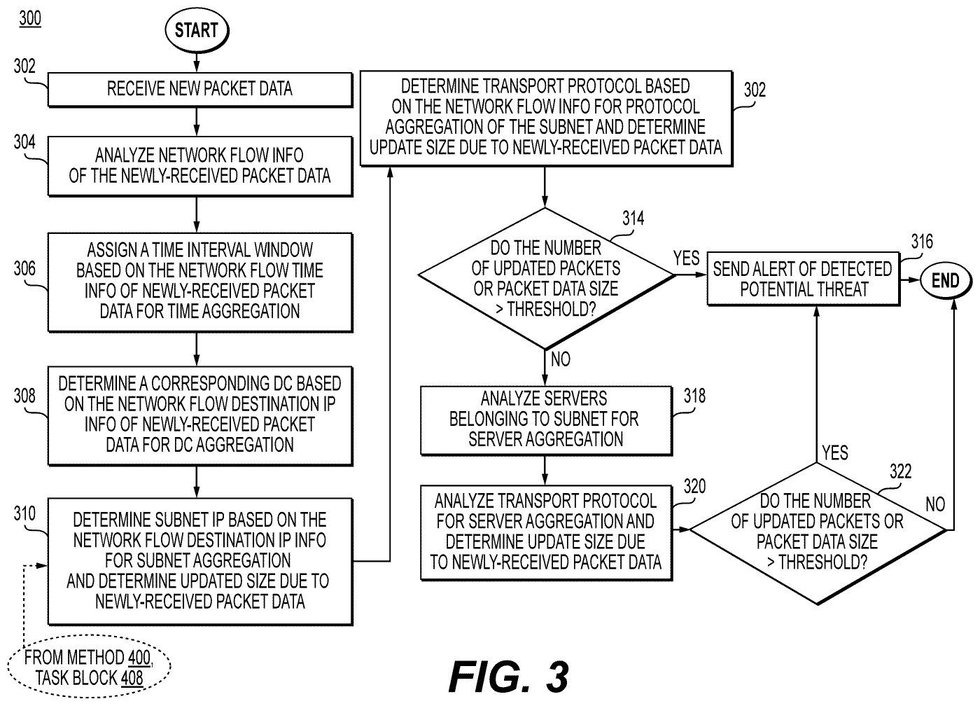

FIG. 3 depicts a flowchart of method 300 for detecting malicious threats based on the aggregation processing architecture 200, in accordance with the embodiments of the present disclosure. As shown, method 300 commences at task block 302 in which new packet data is received by the network and, in task block 304, the network flow information of the newly-received packet data is analyzed for traffic-related metadata. Such metadata includes source/destination IP addresses, port source/destination, number of packets, total size of payload, transmission/reception times, etc. for traffic flowing across network devices.

At task block 306, a time interval window is assigned based on the network flow time for time aggregation. As noted above, time aggregation layer 202 is configured to aggregate packet data for a variety of different time window resolutions, such, for example, 100 ms, 1,000 ms, 10,000 ms, etc. At task block 308, a corresponding datacenter (DC) is determined based on the network flow destination IP info for DC aggregation.

At task block 310, the corresponding subnet IP range is determined based on the network flow destination IP info for subnet aggregation. The subnet IP range is related to the ToR device that may contain up to 256 individual servers. The subnet aggregation updates the number of packets and size based on the newly-received packet data. At task block 312, the transport protocol is determined based on the network flow info for protocol aggregation of the subnet as well as determine the updated number of packets and size based on the newly-received packet data.

At decision block 314, method 300 determines whether the updated number of packets or the total packet data size of the protocol aggregation is greater than a threshold value for the subnet. If so, an alert is sent at task block 316 indicating the detection of a potential threat/attack. If not, method 300 progresses to task block 318 where the servers belonging to the subnet are analyzed for server aggregation.

Then, at task block 320 the transport protocol related to the subnet is analyzed to determine the updated number of packets and the total packet data size of the transport protocol aggregation.

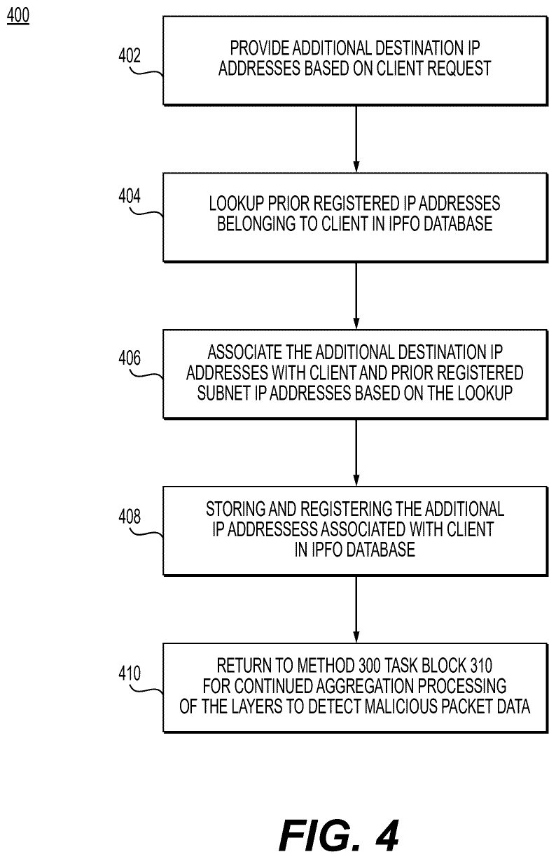

At decision block 322, method 300 determines whether the updated number of packets and the total packet data size of the transport protocol aggregation is greater than a threshold value for the servers and, if so, an alert is sent indicating the detection of a potential threat/attack via task block 316, and method 300 terminates. If it is determined that the packet number or size does not exceed the threshold then method 300 returns back to task block 302 to continue the iteration of aggregating newly-received packet data size and numbers for each of the layers. FIG. 4 depicts a flowchart for a method 400 to service future aggregation processes to detect malicious threats for clients requesting additional destination IP addresses, in accordance with the embodiments of the present disclosure. As shown, method 400 commences at task block 402 wherein method 400 provides additional destination IP addresses based on client requests. At task block 404, method 400 performs a lookup function of IPFO database of prior registered IP addresses belonging to requesting client.

At task block 406, based on the lookup function, method 400 associates and registers the additional destination IP addresses with the requesting client in the IPFO database. Then, task block 408, method 400 returns back to method 300 at task block 310 for the subsequent processing of layers to detect malicious packet data.

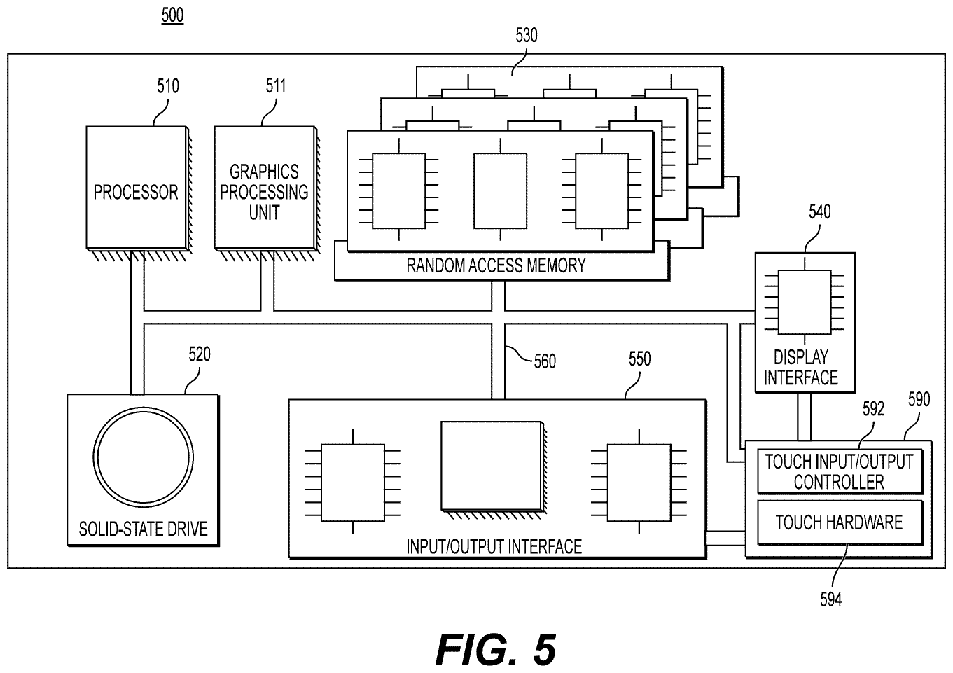

FIG. 5 depicts an exemplary computing environment 500, which may be used to implement and/or execute any of the methods described herein, in accordance with various embodiments of the present disclosure. In some embodiments, the computing environment 500 may be implemented by any of a conventional personal computer, a network device, and/or an electronic device (such as, but not limited to, a mobile device, a tablet device, a server, a controller unit, a control device, etc.), and/or any combination thereof appropriate to the relevant task at hand.

In some embodiments, the computing environment 500 comprises various hardware components including one or more single or multi-core processors collectively represented by processor 510, a solid-state drive 520, a random access memory 530, and an input/output interface 550. The computing environment 500 may be a computer specifically designed to operate a machine learning algorithm (MLA). The computing environment 500 may be a generic computer system.

In some embodiments, the computing environment 500 may also be a subsystem of one of the above-listed systems. In some other embodiments, the computing environment 500 may be an “off-the-shelf” generic computer system. In some embodiments, the computing environment 500 may also be distributed amongst multiple systems. The computing environment 500 may also be specifically dedicated to the implementation of the present technology. As a person in the art of the present technology may appreciate, multiple variations as to how the computing environment 500 is implemented may be envisioned without departing from the scope of the present technology.

Those skilled in the art will appreciate that processor 510 is generally representative of a processing capability. In some embodiments, in place of or in addition to one or more conventional Central Processing Units (CPUs), one or more specialized processing cores may be provided. For example, one or more Graphic Processing Units 511 (GPUs), Quantum Processing Units (QPUs), Tensor Processing Units (TPUs), and/or other so-called accelerated processors (or processing accelerators) may be provided in addition to or in place of one or more CPUs.

System memory will typically include random access memory 530, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 520 is shown as an example of a mass storage device, but more generally such mass storage may comprise any type of non-transitory storage device configured to store data, programs, and other information, and to make the data, programs, and other information accessible via a system bus 560. For example, mass storage may comprise one or more of a solid state drive, hard disk drive, a magnetic disk drive, and/or an optical disk drive.

Communication between the various components of the computing environment 500 may be enabled by a system bus 560 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 550 may enable networking capabilities such as wired or wireless network communications. As an example, the input/output interface 550 may comprise a networking interface such as, but not limited to, a network port, a network socket, a network interface controller and the like. Multiple examples of how the networking interface may be implemented will become apparent to the person skilled in the art of the present technology. For example, the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 550 may be coupled to a touchscreen 590 and/or to the one or more internal and/or external buses 560. The touchscreen 590 may be part of the display. In some embodiments, the touchscreen 590 is the display. The touchscreen 590 may equally be referred to as a screen 590. In the embodiments illustrated in FIG. 1, the touchscreen 590 comprises touch hardware 594 (e.g., pressure-sensitive cells embedded in a layer of a display allowing detection of a physical interaction between a user and the display) and a touch input/output controller 592 allowing communication with the display interface 540 and/or the one or more internal and/or external buses 560. In some embodiments, the input/output interface 550 may be connected to a keyboard (not shown), a mouse (not shown) or a trackpad (not shown) allowing the user to interact with the computing environment 500 in addition to or instead of the touchscreen 590.

According to some implementations of the present technology, the solid-state drive 520 stores program instructions suitable for being loaded into the random access memory 530 and executed by the processor 510 for executing acts of one or more methods described herein. For example, at least some of the program instructions may be part of a library or an application.

The computing environment 500 may include any number of the illustrated components, which may be integrated in any number of physical devices. The computing environment 500 may be implemented as a cloud environment and/or a distributed architecture. The computing environment 500 may include multiple servers, which may be in different physical locations and/or on different networks. The computing environment 500 may include virtualized systems. The methods described herein, or any parts of the methods described herein, may be executed on multiple systems as distributed applications.

With this said, it should be understood that, although the embodiments presented herein have been described with reference to specific features and structures, various modifications and combinations may be made without departing from the underlying concepts and principles taught by these disclosures. As such, the specification and drawings are to be regarded as providing edifying guidance as to the underlying concepts and principles presented by the implementations and embodiments.

Accordingly, the scope encompassed by the underlying concepts and principles presented by the disclosed implementations and embodiments is defined by the appended claims, and are contemplated to cover any and all modifications, variations, combinations or equivalents that fall within the scope of the present disclosure.

What is claimed is:

1. A method for detecting malicious threats by iteratively aggregating network flow information of received packet data, comprising:
analyzing the network flow information of the received packet data;
assigning a time interval window, based on the network flow information of the received packet data, for time aggregation;
determining a corresponding datacenter (DC), based on the network flow destination IP information of the received packet data, for DC aggregation;
determining a corresponding IP subnet range, based on the network flow destination IP information of the received packet data, for subnet aggregation;
evaluating a transport protocol for the IP subnet range and updating the packet data size and/or number of packets based on the received packet data;
determining whether the updated packet data size and/or number of packets of the transport protocol for the IP subnet exceeds a first predefined threshold value;
evaluating a transport protocol for corresponding servers of the IP subnet and updating the packet data size and/or number of packets based on the received packet data; and
determining whether the updated packet data size and/or number of packets of the transport protocol for the server(s) exceeds a second predefined threshold;
wherein:
upon determining that the subnet transport protocol updated packet data size and/or number of packets exceeds the first predefined threshold value, issue an alert indicating the detection of a potential threat, and
upon determining that the server transport protocol updated packet data size and/or number of packets exceeds the second predefined threshold value, issue an alert indicating the detection of a potential threat.

2. The method of claim 1, wherein the network flow information of the received packet data comprises metadata containing one or more of: start and end times of the received packet data, IP destination address of the received packet data, transport protocol of the received packet data, total packet data size of the received packet data, and number of packets of the received packet data.

3. The method of claim 1, wherein the network flow information of the received packet data is used to establish the predefined first and second threshold values.

4. The method of claim 1, wherein, upon determining that the subnet transport protocol updated packet data sizes and/or number of packets do not exceed the first predefined threshold value, continue to evaluate the server transport protocol.

5. The method of claim 1, wherein, upon determining that the server transport protocol updated packet data sizes and/or number of packets do not exceed the second predefined threshold value, iteratively return back to evaluate subsequently newly-received packet data.

6. The method of claim 1, further comprising provisioning additional destination IP addresses requested by a client by:
providing additional destination IP addresses requested by client;
performing a lookup function of a database to identify stored prior registered IP addresses belonging to the requesting client;
associating the additional destination IP addresses into the database, based on the identified stored prior registered IP addresses; and
registering and storing the additional IP addresses associated with the requesting client in the database.

7. The method of claim 5 wherein, after registering and storing the additional IP addresses for the requesting client, returning back to the aggregation processing of the method.

8. The method of claim 1, wherein selection of the packet data to be received is based, in part, on a netflow traffic-based statistical sampling process.

9. A system for detecting malicious threats by iteratively aggregating network flow information of received packet data, comprising:
a network communications infrastructure configured to facilitate transport of the received packet data and to direct the received packet data to an intended destination, based on the corresponding network flow information of the received packet data identifying a destination IP address;
at least one datacenter (DC), in communications with the network communications infrastructure, comprising at least one top-of-rack (ToR) network switching device configured to manage a plurality of servers associated with an IP subnet;
a time aggregation layer configured to assign a time interval window for the received packet data based on the corresponding network flow information identifying a start time and end time;
a DC aggregation layer configured to determine a corresponding DC that services a range of IP addresses encompassing the destination IP address based on the network flow information identified destination IP address;
a subnet aggregation layer configured to:
determine an IP subnet and related subnet transport protocol based on the network flow information,
evaluate the subnet transport protocol and update the packet data size and/or number of packets based on the received packet data network flow information, and
determine whether the updated packet data size and/or number of packets of the subnet transport protocol exceeds a first predefined threshold value;
a server aggregation layer configured to:
determine server(s) corresponding to the IP subnet and related server transport protocol based on the network flow information,
evaluate the server transport protocol and update the packet data size and/or number of packets based on the received packet data network flow information, and
determine whether the updated packet data size and/or number of packets of the server transport protocol exceeds a second predefined threshold value;
wherein:
upon determining that the subnet transport protocol updated packet data size and/or number of packets exceeds the first predefined threshold value, issue an alert indicating a detection of a potential threat; and
upon determining that the server transport protocol updated packet data size and/or number of packets exceeds the second predefined threshold value, issue an alert indicating the detection of a potential threat.

10. The system of claim 9, wherein the network flow information of the received packet data comprises metadata containing one or more of: the start and end times of the received packet data, IP destination address of the received packet data, transport protocol of the received packet data, total packet data size of the received packet data, and number of packets of the received packet data.

11. The system of claim 9, wherein the network flow information of the received packet data is used to establish the predefined first and second threshold values.

12. The system of claim 9, further comprising a future aggregation layer configured to:
provide additional destination IP addresses requested by a client;
perform a lookup function of a database to identify prior stored registered IP addresses belonging to the requesting client;
associate the additional destination IP addresses with the requesting client, based on the identified stored prior registered IP addresses; and
register and store the additional IP addresses associated with the requesting client in the database.

13. The system of claim 9, wherein selection of the packet data to be received is based, in part, on a netflow traffic-based statistical sampling process.

14. A non-transitory computer-readable medium comprising computer-executable instructions that, when executed by a processor, causes the processor to execute a method for detecting malicious threats by iteratively aggregating network flow information of received packet data, the method comprising:
analyzing the network flow information of the received packet data;
assigning a time interval window, based on the network flow information of the received packet data, for time aggregation;
determining a corresponding datacenter (DC), based on the network flow destination IP information of the received packet data, for DC aggregation;
determining a corresponding IP subnet range, based on the network flow destination IP information of the received packet data, for subnet aggregation;
evaluating a transport protocol for the IP subnet range and updating the packet data size and/or number of packets based on the received packet data;
determining whether the updated packet data size and/or number of packets of the transport protocol for the IP subnet exceeds a first predefined threshold value;
evaluating a transport protocol for corresponding servers of the IP subnet and updating the packet data size and/or number of packets based on the received packet data; and
determining whether the updated packet data size and/or number of packets of the transport protocol for the server(s) exceeds a second predefined threshold;
wherein:
upon determining that the subnet transport protocol updated packet data size and/or number of packets exceeds the first predefined threshold value, issue an alert indicating the detection of a potential threat, and
upon determining that the server transport protocol updated packet data size and/or number of packets exceeds the second predefined threshold value, issue an alert indicating the detection of a potential threat.

15. The non-transitory computer-readable medium of claim 14, wherein the network flow information of the received packet data comprises metadata containing one or more of: start and end times of the received packet data, IP destination address of the received packet data, transport protocol of the received packet data, total packet data size of the received packet data, and number of packets of the received packet data.

16. The non-transitory computer-readable medium of claim 14, wherein the network flow information of the received packet data is used to establish the predefined first and second threshold values.

17. The non-transitory computer-readable medium of claim 14, wherein, upon determining that the subnet transport protocol updated packet data sizes and/or number of packets do not exceed the first predefined threshold value, continue to evaluate the server transport protocol.

18. The non-transitory computer-readable medium of claim 14, wherein, upon determining that the server transport protocol updated packet data sizes and/or number of packets do not exceed the second predefined threshold value, iteratively return back to evaluate subsequently newly-received packet data.

19. The non-transitory computer-readable medium of claim 14, further comprising provisioning additional destination IP addresses requested by a client by:
providing additional destination IP addresses requested by client;
performing a lookup function of a database to identify stored prior registered IP addresses belonging to the requesting client;
associating the additional destination IP addresses into the database, based on the identified stored prior registered IP addresses; and
registering and storing the additional IP addresses associated with the requesting client in the database.

20. The non-transitory computer-readable medium of claim 18, wherein, after registering and storing the additional IP addresses for the requesting client, returning back to the aggregation processing of the method.
